(19) United States
(12) Patent Application Publication
(10) Pub. No.: US 2024/0228110 A9
(43) Pub. Date: Jul. 11, 2024

(54) FOLDABLE TRANSPORT CONTAINERS

(71) Applicant: CABKA Group GmbH, BERLIN (DE)

(72) Inventors: Gat RAMON, Berlin (DE); Guillermo SANTAMANS PONS, Riba-roja de Turia (ES)

(73) Assignee: CABKA Group GmbH, Berlin (DE)

(21) Appl. No.: 18/277,607

(22) PCT Filed: Feb. 16, 2022
(86) PCT No.: PCT/IB2022/051370

§ 371 Date: Aug. 17, 2023

Related U.S. Application Data
(60) Provisional application No. 63/214,354, filed on Jun. 24, 2021.
(60) Provisional application No. 63/150,100, filed on Feb. 17, 2021.

(51) Int. Cl. B65D 19/18

(52) U.S. Cl. CPC B65D 19/18; B65D 2519/00169; B65D 2519/00174; B65D 2519/00184; B65D 2519/00502; B65D 2519/00517; B65D 2519/009

(57) ABSTRACT

The present invention relates to a hybrid panel, comprising a panel comprising: a core, a first protecting layer on a first side of said core and a second protecting layer on a second side of said core; said panel defining an outside geometry thereof; and an overmolded portion which overlays at least a part of said panel, thereby changing said geometry of said panel at said part of said panel.

### RELATED APPLICATION/S

This application claims the benefit of priority of U.S. Provisional Patent Application No. 63/150,100 filed on 17 Feb. 2021 and of U.S. Provisional Patent Application No. 63/214,354 filed on 24 Jun. 2021, the contents of which are incorporated herein by reference as if fully set forth herein in their entirety.

### FIELD AND BACKGROUND OF THE INVENTION

The present invention, in some embodiments thereof, relates to transport containers and, more particularly, but not exclusively, to foldable transport containers with improved technical advantages.

Additional background art includes U.S. Pat. No. 7,479,246B2 disclosing “in the overmoulding of an article channels are provided in the surface of the article to guide the flow of the overmoulding material, in addition holes may be provided across the article to enable flow of the overmoulding material to the side of the carrier remote from the point of injection. The techniques are particular useful in the overmoulding of articles having a lattice or honeycomb structure particularly when produced by injection moulding. When the overmoulding material is foamable the overmoulded articles may be used as acoustic baffles or structural reinforcement for automobiles”.

U.S. Pat. No. 1,012,451B2 discloses a method for producing a two-dimensional composite component having a porous basic component and an injection molded component rigidly joined to the basic component, said method comprising the following steps: introduction of the mat-like or panel-like basic component, comprising two mutually spaced-apart base sides and a circumferential narrow side joining the base sides, into a basic component cavity of a molding tool, which further comprises an injection molding cavity, closure of the molding tool, so that at least a portion of the basic component forms a portion of a wall of the injection molding cavity, and injection of injection molding material into the injection molding cavity, and formation thereby of the injection molding component and joining of the injection molding component to the basic component, wherein upon closure of the molding tool before the injection molding material is injected, the entire region, formed by the basic component, of the wall of the injection molding cavity is formed by the narrow side of the basic component.

U.S. Patent Application Publication No. 20190213990A1 discloses panels comprising first and second layers and a core disposed there between, wherein the core has a plurality of walls providing a series of connected cells, wherein some of the cell walls have openings providing fluid communication between a series of at least 3 cells, and wherein the opening in a cell wall has an area that is at least 50 percent of the area of a side of that cell wall.

U.S. Patent Application Publication No. 20190375176A1 discloses a load structure that may include a panel having a core, and a coating of polyurethane around the core. The load structure may also have a layer of carpet or felt on at least a portion of a first side of the panel. The load structure may further include an over mold coating on a second side of the panel.

International Patent Application No. WO2009098423A2 discloses a method for making a cellular structure, including a cellular panel and a complementary element, said cellular panel including a honeycomb core sandwiched in between two cover plates. The latter has cells oriented substantially perpendicularly to said cover plates. According to the method, a linking area is selected to connect said complementary element to said cellular panel and cells of said linking area are packed with a bulk of plastic material to anchor said complementary element inside said honeycomb core. According to the invention, said complementary element made of plastic material is pre-cast through one of said cover plates in said linking area so as to pack said cells with said bulk of plastic material and to form said complementary element.

U.S. Pat. No. 5,989,473A discloses a molding process in which a material with an open cell, porous structure is placed, aligned or supported inside a suitable enclosed holding device. Another molding material is subsequently injected into the said holding device while gas and/or pressure is sequentially applied to the said holding device, causing a synergistic interaction and joining between the said materials to take place. During the processing phase, gas is evenly dispersed throughout the porous core, effectively equalizing cavity pressure and permitting an even flow pattern to exist, encapsulating or sandwiching the said porous structure, thus forming a composite material with physical properties which are substantially greater than the individual components.

### SUMMARY OF THE INVENTION

Following is a non-exclusive list including some examples of embodiments of the invention. The invention also includes embodiments which include fewer than all the features in an example and embodiments using features from multiple examples, also if not expressly listed below.

### Example 1

An hybrid panel, comprising
a. a panel comprising: a core, a first protecting layer on a first side of said core and a second protecting layer on a second side of said core; said panel defining an outside geometry thereof;
b. an overmolded portion which overlays at least a part of said panel, thereby changing said geometry of said panel at said part of said panel.

### Example 2

The hybrid panel according to example 1, wherein said overmolded portion provides a structural function.

### Example 3

The hybrid panel according to example 1 or example 2, wherein said core is thinner at a location of connection between said overmolded portion and said panel in relation of the rest of said core where there is no connection with said overmolded portion.

### Example 4

The hybrid panel according to examples 1-3, wherein said core is made of one or more of thermoplastic material, resin, reinforced resin, wood and concrete.

### Example 5

The hybrid panel according to examples 1-4, wherein said first and said second protecting layers are made of one or more of thermoplastic material, resin, reinforced resin, wood and concrete.

### Example 6

The hybrid panel according to examples 1-5, wherein said overmolded portion is made of one or more of thermoplastic material, resin and reinforced resin.

### Example 7

The hybrid panel according to examples 1-6, wherein said panel is a sandwich panel.

### Example 8

The hybrid panel according to examples 1-7, wherein said core is a honeycomb core.

### Example 9

A method of manufacturing a hybrid panel, comprising:
a. providing a panel;
b. overmolding with enough material to change a geometry on at least a part of said panel.

### Example 10

The method according to example 9, wherein said change a geometry comprises providing a structural function with said change.

### Example 11

The method according to example 9 or example 10, wherein said enough material comprises providing an overmolding portion of at least 2 mm thickness,

### Example 12

The method according to any one of examples 9-11, wherein said manufacturing a mold for a panel further comprises manufacturing a mold comprising mold for parts that provide functional elements to be added to said panel.

### Example 13

The method according to any one of examples 9-12, wherein said providing a panel comprises providing a panel comprising a honeycomb core, a first protecting layer on a first side of said honeycomb core and a second protecting layer on a second side of said honeycomb core.

### Example 14

The method according to any one of examples 9-13, wherein said providing a panel comprises providing a panel comprising a wooden core, a first protecting layer on a first side of said wooden core and a second protecting layer on a second side of said wooden core.

### Example 15

The method according to any one of examples 9-13, wherein said providing a panel comprises providing a panel comprising a thermoplastic core, a first protecting layer on a first side of said thermoplastic core and a second protecting layer on a second side of said thermoplastic core.

### Example 16

The method according to any one of examples 9-13, wherein said providing a panel comprises providing a panel comprising a resin core, a first protecting layer on a first side of said resin core and a second protecting layer on a second side of said resin core.

### Example 17

The method according to any one of examples 9-13, wherein said providing a panel comprises providing a panel comprising a reinforced resin core, a first protecting layer on a first side of said reinforced resin core and a second protecting layer on a second side of said reinforced resin core.

### Example 18

The method according to any one of examples 9-13, wherein said providing a panel comprises providing a panel comprising a concrete core, a first protecting layer on a first side of said concrete core and a second protecting layer on a second side of said concrete core.

### Example 19

The method according to any one of examples 9-18, wherein said material is thermoplastic material.

### Example 20

The method according to any one of examples 9-19, wherein said material is recycled thermoplastic material.

### Example 21

An hybrid panel, comprising
a. a panel comprising: a core, a first protecting layer on a first side of said core and a second protecting layer on a second side of said core;
b. an overmolded portion comprising one or more elements comprising structural functions.

### Example 22

The hybrid panel according to example 21, wherein said panel defines an outside geometry thereof.

### Example 23

The hybrid panel according to example 21 or example 22, wherein said core is thinner at a location of connection between said overmolded portion and said panel in relation of the rest of said core where there is no connection with said overmolded portion.

### Example 24

The hybrid panel according to examples 21-23, wherein said core is made of one or more of thermoplastic material, resin, reinforced resin, wood and concrete.

### Example 25

The hybrid panel according to examples 21-24, wherein said first and said second protecting layers are made of one or more of thermoplastic material, resin, reinforced resin, wood and concrete.

### Example 26

The hybrid panel according to examples 21-25, wherein said overmolded portion is made of one or more of thermoplastic material, resin and reinforced resin.

### Example 27

The hybrid panel according to examples 21-26, wherein said panel is a sandwich panel.

### Example 28

The hybrid panel according to examples 21-27, wherein said core is a honeycomb core.

### Example 29

A method of manufacturing a hybrid panel, comprising:
a. providing a panel;
b. overmolding one or more elements comprising structural functions on at least a part of said panel.

### Example 30

The method according to example 29, wherein said overmolding one or more elements comprising structural functions on at least a part of said panel further comprises changing a geometry on said at least a part of said panel.

### Example 31

The method according to example 30, wherein said changing a geometry is performed by overmolding with enough material to change said geometry on said at least a part of said panel.

### Example 32

The method according to any one of examples 29-31, wherein said enough material comprises providing an overmolding portion of at least 2 mm thickness,

### Example 33

The method according to any one of examples 29-32, wherein said manufacturing a mold for a panel further comprises manufacturing a mold comprising mold for parts that provide functional elements to be added to said panel.

### Example 34

The method according to any one of examples 29-33, wherein said providing a panel comprises providing a panel comprising a honeycomb core, a first protecting layer on a first side of said honeycomb core and a second protecting layer on a second side of said honeycomb core.

### Example 35

The method according to any one of examples 29-34, wherein said providing a panel comprises providing a panel comprising a wooden core, a first protecting layer on a first side of said wooden core and a second protecting layer on a second side of said wooden core.

### Example 36

The method according to any one of examples 29-34, wherein said providing a panel comprises providing a panel comprising a thermoplastic core, a first protecting layer on a first side of said thermoplastic core and a second protecting layer on a second side of said thermoplastic core.

### Example 37

The method according to any one of examples 29-34, wherein said providing a panel comprises providing a panel comprising a resin core, a first protecting layer on a first side of said resin core and a second protecting layer on a second side of said resin core.

### Example 38

The method according to any one of examples 29-34, wherein said providing a panel comprises providing a panel comprising a reinforced resin core, a first protecting layer on a first side of said reinforced resin core and a second protecting layer on a second side of said reinforced resin core.

### Example 39

The method according to any one of examples 29-34, wherein said providing a panel comprises providing a panel comprising a concrete core, a first protecting layer on a first side of said concrete core and a second protecting layer on a second side of said concrete core.

### Example 40

The method according to any one of examples 29-39, wherein said material is thermoplastic material.

### Example 41

The method according to any one of examples 29-40, wherein said material is recycled thermoplastic material.

### Example 42

A container comprising a plurality of panels, said panels comprising overmolded strengthening portions.

### Example 43

The container according to example 42, wherein said overmolded strengthening portions provide structural functions.

### Example 44

The container according to example 42 or example 43, wherein said overmolded portion comprises fastening means to attach the hybrid panel to at least one adjacent panel.

### Example 45

The container according to any one of examples 42-44, wherein said overmolded portion comprises hinge means to allow the hybrid panel to rotate between at least one adjacent panel.

### Example 46

The container according to any one of examples 42-45, wherein said overmolded panels are joined to a pallet-shaped base.

### Example 47

A pallet comprising:
a. a panel comprising a plurality of edges; and
b. overmolded strengthening portions connected to said edges.

### Example 48

The pallet according to example 47, wherein said overmolded strengthening portions provide structural functions.

### Example 49

The pallet according to example 47 or example 48, wherein at least one of said plurality of edges is located inside the surface of said panel.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic representation of a hybrid panel, according to some embodiments of the invention;

FIG. 2 is a schematic representation of an exemplary panel, according to some embodiments of the invention;

FIG. 3 is a schematic representation of a cross section of an exemplary hybrid panel, according to some embodiments of the invention;

FIG. 4 is an exemplary product comprising a plurality of hybrid panels, according to some embodiments of the invention;

FIG. 5 is a flowchart of an exemplary method of planning exemplary frames for the exemplary hybrid panels, according to some embodiments of the invention;

FIGS. 6a-c are schematic representations of an exemplary pallet made from a hybrid panel, according to some embodiments of the invention;

FIG. 6d is a flowchart of an exemplary method of manufacturing a pallet made of a hybrid panel, according to some embodiments of the invention;

FIGS. 7a-i are schematic representations of an exemplary pallet with foldable walls made from a plurality of hybrid panels, according to some embodiments of the invention;

FIG. 7j is a flowchart of an exemplary method of manufacturing a pallet with foldable walls made of a plurality of hybrid panels, according to some embodiments of the invention;

FIGS. 8a-b are schematic representations of an exemplary rigid container, according to some embodiments of the invention; and

FIG. 8c is a flowchart of an exemplary method of manufacturing an exemplary rigid container made of a hybrid panel, according to some embodiments of the invention.

### DESCRIPTION OF SPECIFIC EMBODIMENTS OF THE INVENTION

The present invention, in some embodiments thereof, relates to structural hybrid panels and, more particularly, but not exclusively, to structural hybrid panels with improved technical advantages.

### Overview

An aspect of some embodiments of the invention relates to transport container configured to be folded and having improved technical features. In some embodiments, the transport container is lighter in comparison to known similar transport containers. In some embodiments, the transport container is lighter from about 5% to about 10% than known similar transport containers. In some embodiments, the transport container is stronger in comparison to known similar transport containers. In some embodiments, the transport container is stronger from about 30% to about 60% than known similar transport containers. In some embodiments, the transport container is configured to carry higher loads in comparison to known similar transport containers. In some embodiments, the transport container is configured to carry from about 5% to about 10% more load than known similar transport containers. In some embodiments, the transport container is configured to have more space for loads in comparison to known similar transport containers. In some embodiments, the transport container is configured to have from about 5% to about 10% more space for loads than known similar transport containers. In some embodiments, the surfaces of the walls of the transport container are flat and without areas where dirt can potentially accumulate. In some embodiments, the internal surfaces of the transport container are flat and without either protrusions or indentations that can potentially damage the goods inside the transport container.

An aspect of some embodiments of the invention relates to structural hybrid panels comprising a combination of a resistant lightweight panel with a functional frame to potentially obtain products with improved technical advantages. In some embodiments, the functional frame is made of plastic, optionally recycled plastic. In some embodiments, the lightweight panels comprise a honeycomb internal structure and/or an alveolar internal structure. In some embodiments, the functional frame is incorporated into the resistant lightweight panel by one or more processes, for example overmolding process, joint panels by one or more processes, for example, gluing, welding, snapping, riveting and screwing. In some embodiments, the frame comprises functional structures that are added to the panel by one or more processes, for example injection molding processes, gluing, welding, snapping, riveting and screwing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

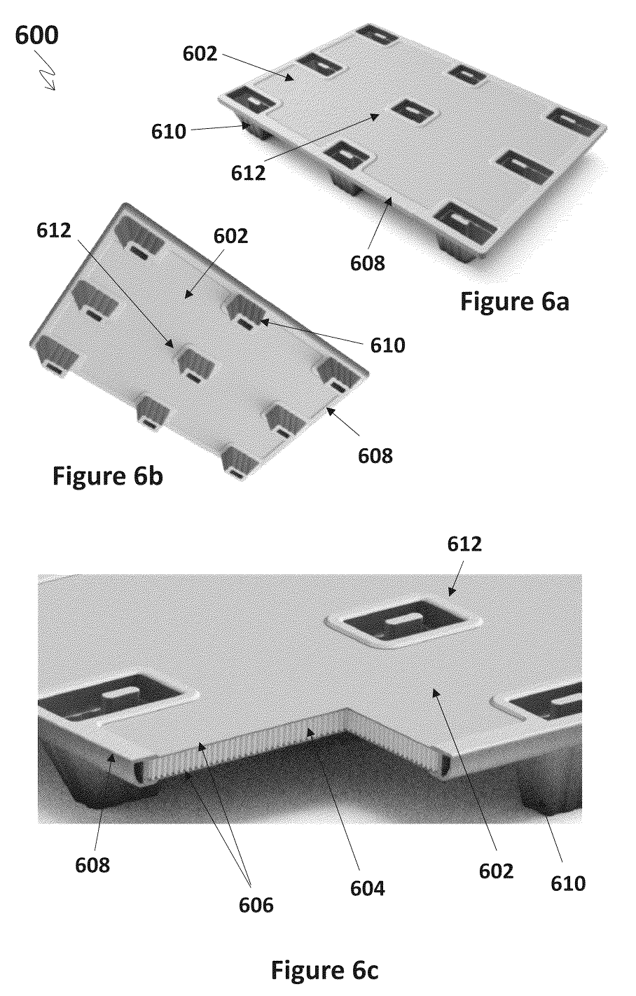

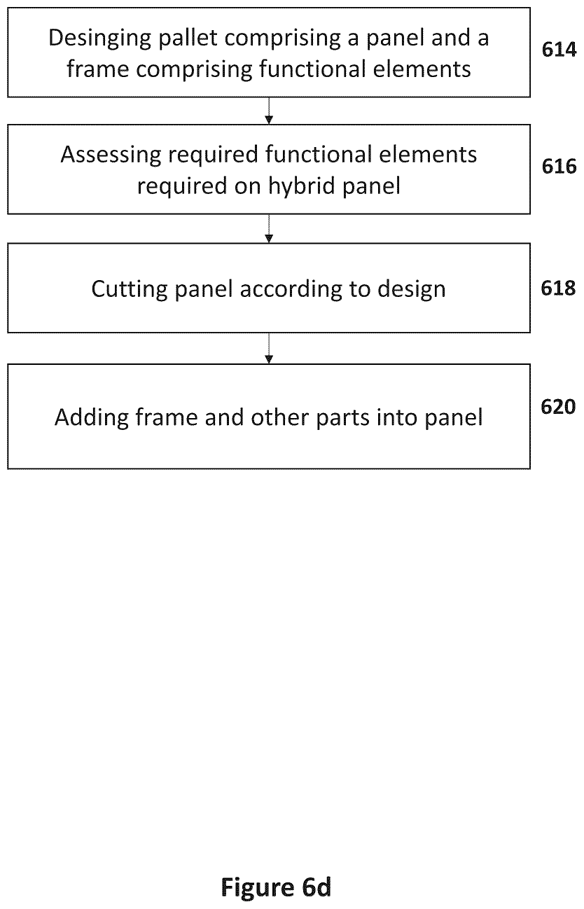

To ease the explanations the following terminology will be constantly used over the description of the invention. The term “hybrid panel” refers hereinafter to the final product achieved by the combination of a panel with a frame. The term “panel” refers hereinafter to the panel that is used where the addition of the frame will be performed by one or more processes, for example injection molding, gluing, welding, snapping, riveting and screwing. The term “frame” refers hereinafter to the parts of the hybrid panel that are added to the mold and optionally comprises one or more functional elements. It should be understood, also in view of the following explanations, that the additional parts are not limited to a frame, as will be seen for example in FIGS. 6a-c, part 612, where additional parts are added to the panel but are not limited to a frame.

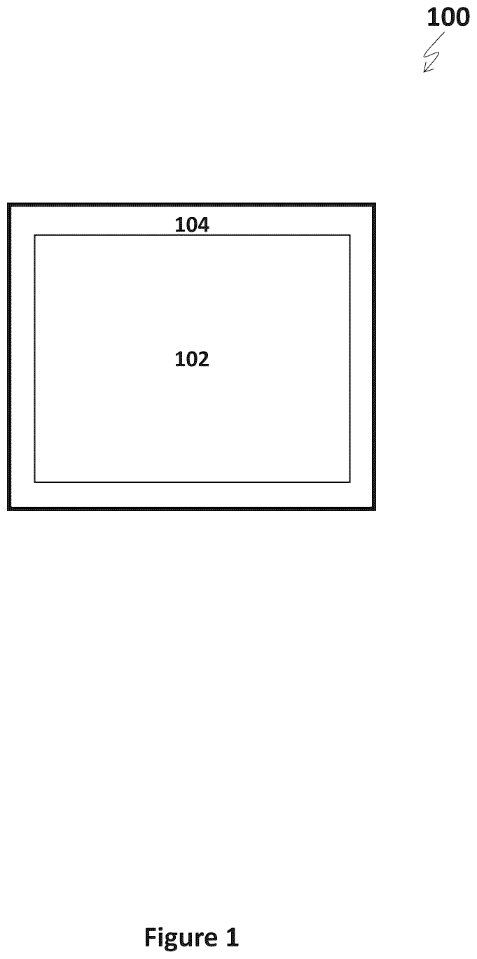

Referring now to FIG. 1, showing a schematic representation of a hybrid panel 100, according to some embodiments of the invention. In some embodiments, the hybrid panel comprises a panel 102 on which, by using one or more processes, for example injection overmolding processes, gluing processes, welding processes, snapping processes, riveting processes and screwing processes, a frame (additional parts) 104 optionally comprising one or more functional elements (not shown in FIG. 1) are added. In some embodiments, the one or more functional elements are added a priori to the frame. In some embodiments, the panel comprises a geometry, and the addition of the parts (frame and/or others) changes the geometry of the panel, as will be further evidenced by the explanations and examples below.

### Exemplary Panel

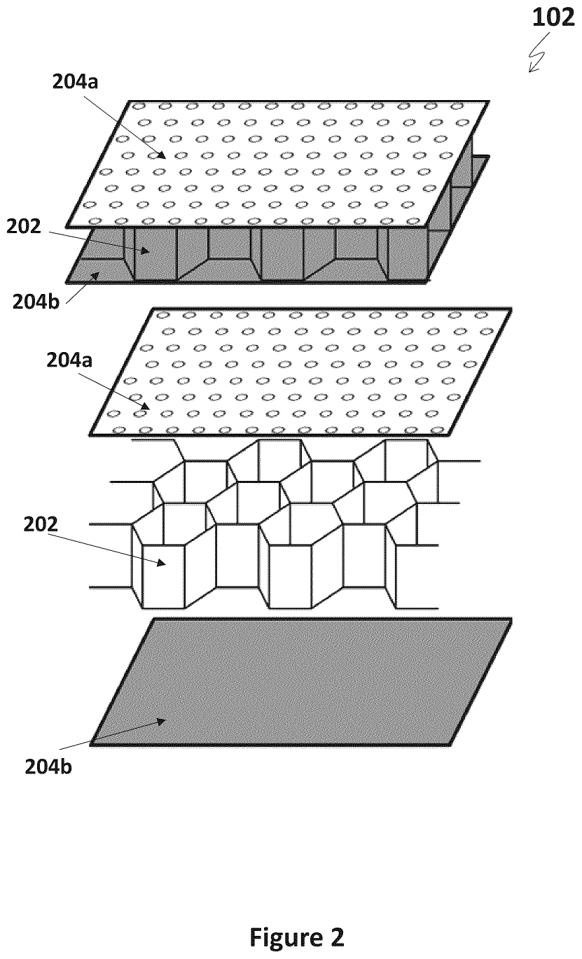

Referring now to FIG. 2, showing a schematic representation of an exemplary panel 102, according to some embodiments of the invention. In some embodiments, the panel 102 comprises an internal structure (core), optionally comprising an alveolar and/or honeycomb core structure 202 covered by a protective layer 204a-b on both sides. In some embodiments, this is called a sandwich-structure composite. In some embodiments, a sandwich-structured composite is a class of composite materials that is fabricated by attaching two thin but stiff skins to a lightweight but thick core. In some embodiments, the core material is optionally low strength material, but its higher thickness potentially provides the sandwich composite with high bending stiffness with overall low density. In some embodiments, the core materials can be one or more of an open-cell-structured and/or a closed-cell-structured made of one or more of foams, for example polyethersulfone polyvinylchloride, polyurethane, polyethylene or polystyrene foams, or made of balsa wood, syntactic foams, or paper/recycled paper made and/or derived materials, thermoplastic material, resin, reinforced resin or concrete. In some embodiments, the core materials are made of plastic, optionally recycled plastic. In some embodiments, optionally, the honeycomb structure is filled with other foams for added strength. In some embodiments, optionally, open- and closed-cell metal foam are used as core materials. In some embodiments, laminates of glass or carbon fiber-reinforced thermoplastics or thermoset polymers (unsaturated polyesters, epoxies . . . ), resin, reinforced resin, wood or concrete are used as skin materials. In some embodiments, optionally, sheet metal is also used as skin material in some cases. In some embodiments, the skin materials are made of plastic, optionally recycled plastic. In some embodiments, the core is bonded to the skins with an adhesive or with metal components by brazing together.

In some embodiments, the sandwich structure comprises a metal composite material (MCM) formed from two thin skins of metal bonded to a plastic core in a continuous process under controlled pressure, heat, and tension. In some embodiments, the sandwich structure comprises a recycled paper over a closed-cell recycled kraft honeycomb core, therefore providing a lightweight, strong, and fully repulpable composite board.

In some embodiments, the core type and the way the core supports the skins, sandwich structures are divided into the following groups: homogeneously supported, locally supported, regionally supported, unidirectionally supported, bidirectionally supported.

In some embodiments, the panel comprises a geometry, for example, a square, a rectangle, a circle, or any other geometrical form. In some embodiments, the geometry is changed by the addition of the frame and/or the additional elements during the injection molding process. In some embodiments, the panel is prepared for the injection process by cutting parts of it, according to the technical needs of the final product.

In some embodiments, the mechanical strength of a hybrid panel is from about 40% to about 50% higher than a panel alone. Optionally from about 30% to about 60% higher than a panel alone. Optionally from about 20% to about 70% higher than a panel alone. In some embodiments, the difference in strength is provided by the overmolded portions. In some embodiments, the difference in strength is provided by the internal structure of the panels used in the hybrid panels.

In some embodiments, the panel can be completely or partially transparent, by using for example panels of transparent polycarbonate, thereby providing a hybrid panel where a user con look inside the final product.

### Exemplary Connection Between Panel and Frame

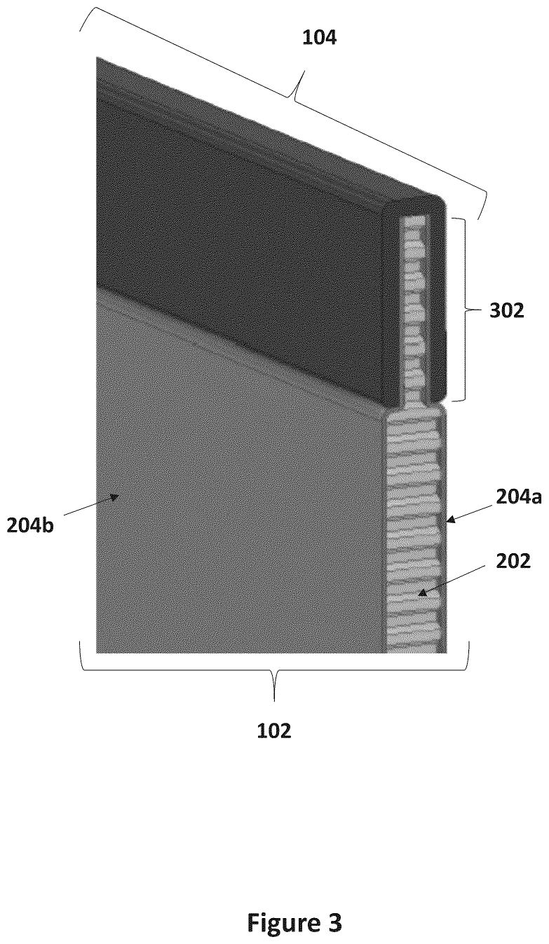

Referring now to FIG. 3, showing a schematic representation of a cross section of an exemplary hybrid panel, according to some embodiments of the invention. In some embodiments, as mentioned above, the hybrid panel comprises a panel 102, which optionally comprises an alveolar core (or honeycomb core) 202 covered on both sides by a protective layer 204a-b, and a frame 104, which is overmolded on the panel, optionally by a process of injection molding. In some embodiments, the panel comprises an area comprising a reduction in the thickness of the alveolar core 302. In some embodiments, the frame is overmolded on the panel at that area of reduction of the thickness of the alveolar core. In some embodiments, optionally, the thickness of the frame is calculated so it will complement the difference in the thickness of the alveolar core. In some embodiments, a potential advantage of this is that this provides a hybrid panel having the same thickness along the whole surface. In some embodiments, the overmolding of the frame is performed on a panel that do not comprise a reduction in the alveolar core. In some embodiments, there will be a difference in the thickness between the frame and the panel in the hybrid panel (as shown for example in the pallet shown in FIGS. 6a-6c).

In some embodiments, the frame comprising the functional elements is manufactured around the panel. In some embodiments, the frame comprising the functional elements is manufactured inside the area of the panel, as shown for example in FIGS. 6a-6c, part 612 of pallet 600.

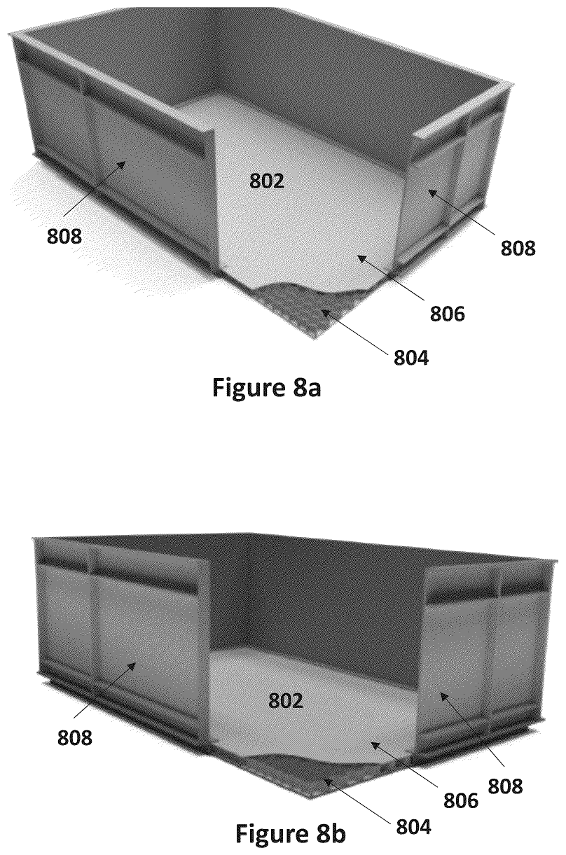

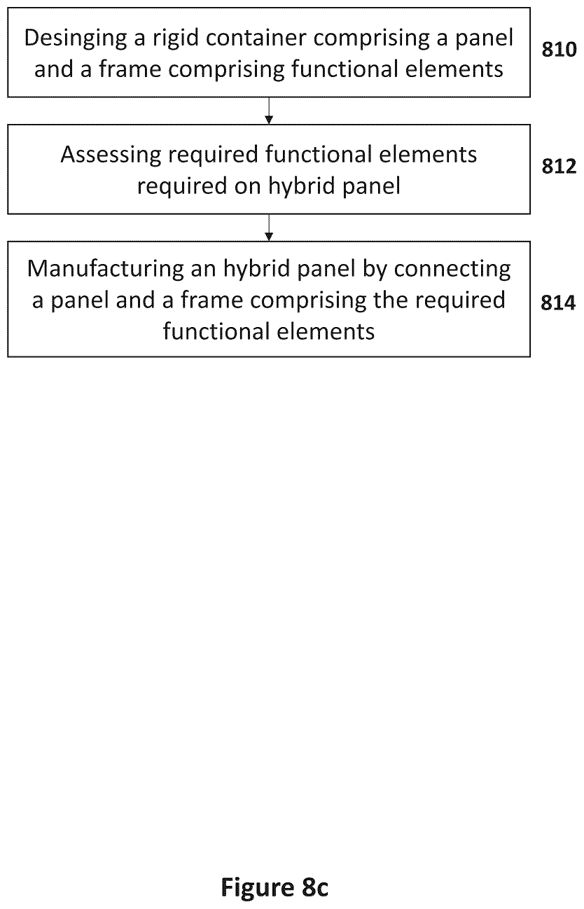

In some embodiments, the frame comprising the functional elements change the geometry of the panel. For example, in some embodiments, the panel is a flat panel having certain dimensions that define a geometry of the panel. In some embodiments, the addition of the frame changes that geometry by adding elements that change those dimensions and/or add one or more dimensions to the dimensions already found in the panel (for example from planar to tridimensional as seen for example in FIGS. 8a-b).

In some embodiments, the overmolding portions added to the frame comprise a thickness of from about 2 mm to about 10 mm, optionally from about 1 mm to about 20 mm, optionally form about 0.5 mm to about 50 mm. In some embodiments, the overmolding portions provide strengthening characteristics to the panel, for example: an increase in mechanical strength of from about 40% to about 50%. Optionally from about 30% to about 60%. Optionally from about 20% to about 70%.

### Exemplary Non-Overmoulded Connection Between Panel and Frame

In some embodiments, as mentioned above, the hybrid panel comprises a panel 102, which optionally comprises an alveolar core (or honeycomb core) 202 covered on both sides by a protective layer 204a-b, and a frame 104, which are connected to each other by processes other than overmoulding, for example gluing processes, welding processes, snapping processes, riveting processes and screwing processes.

### Exemplary Planning of an Exemplary Frame

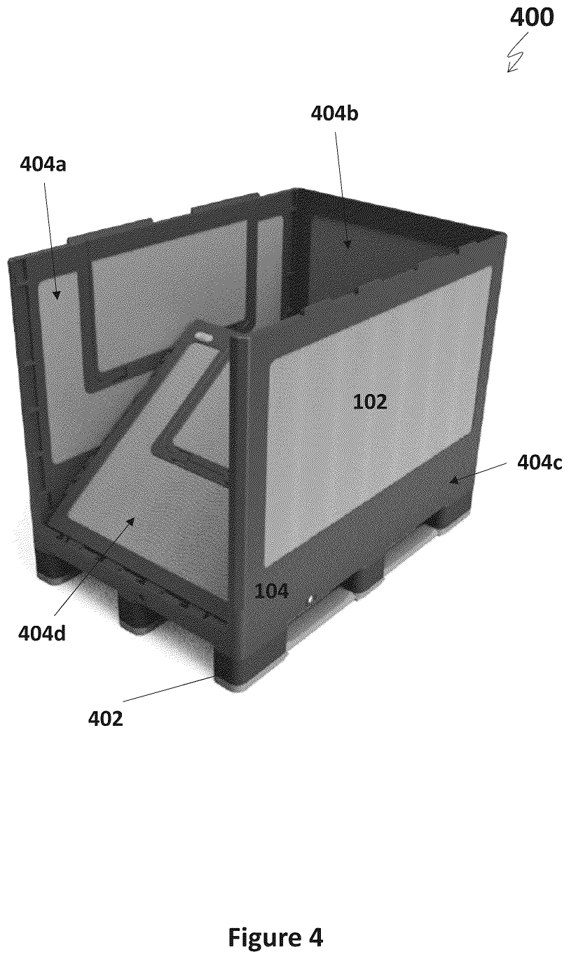

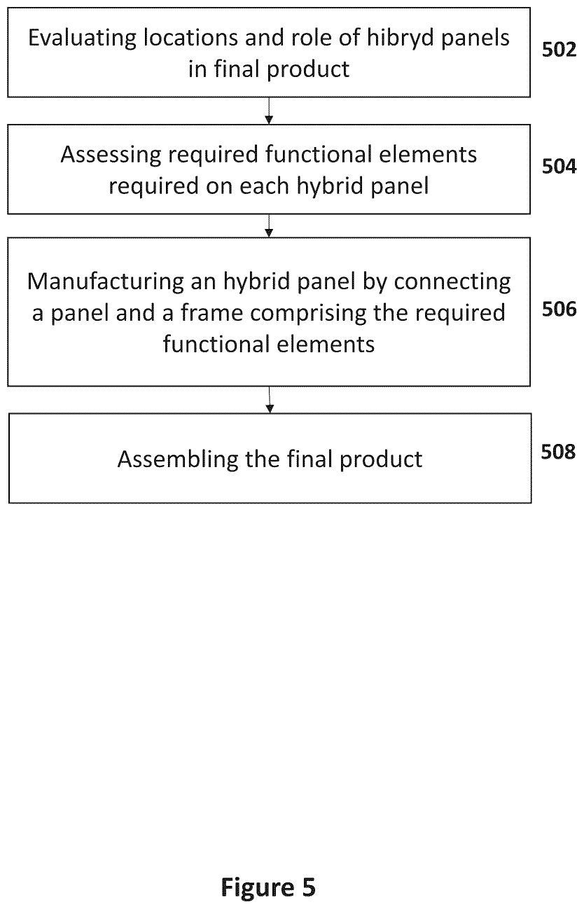

In order to facilitate the explanations, an example will be used to hopefully ease the understanding of the invention to a person having skills in the art. It should be understood that the example is just that, an example, and it should not limit the scope of the invention in any way. Referring now to FIG. 4 and FIG. 5, FIG. 4 showing an exemplary product comprising a plurality of hybrid panels, according to some embodiments of the invention, and FIG. 5 showing a flowchart of an exemplary method of planning exemplary frames for the exemplary hybrid panels used in the exemplary product shown in FIG. 4, according to some embodiments of the invention.

Referring now to FIG. 4, showing an exemplary product 400 comprising a plurality of hybrid panels, according to some embodiments of the invention. In some embodiments, the product is a pallet with foldable walls 400 used, for example, for transporting goods. In some embodiments, the pallet comprises a base 402 and four foldable walls 404a-d. In some embodiments, one or more of the four foldable walls 404a-d are hybrid panels, where the center of the foldable wall is a panel 102 and the plastic around it is the frame 104, as shown for example on foldable wall 404c in FIG. 4. In some embodiments, in order to generate the foldable wall 404c of the pallet with foldable walls 400, a planning process is performed. In some embodiments, the planning process comprises evaluating what are the necessary functional elements required for each hybrid panel.

Referring now to FIG. 5, showing a flowchart of an exemplary method of planning exemplary frames for the exemplary hybrid panels, according to some embodiments of the invention. In some embodiments, the method comprises one or more of the following parts. It should be understood that the following method is an exemplary method and it is disclosed to allow a person having skills in the art to understand the invention. It should be understood that the following method should not limit the invention in any form.

### Evaluating Final Product

In some embodiments, the planning process commences by evaluating the locations and roles of the hybrid panels in a final product 502. For example, the foldable walls of the pallet with foldable walls 400 are located on top of the base 402 and their role is dual, when open, they provide protection to what is stored on the pallet, and when closed, they allow easy transport of the pallet without taking too much space.

### Assessing Required Functional Elements

In some embodiments, each hybrid panel is assessed for the required functional elements 504. For example, the foldable walls of the pallet with foldable walls 400 are interconnected to the base, for example, by built-in hinges located half on the frame and half on the base (they interconnect by clicking them together). Another example, for foldable wall 404b, on the internal side of the side of the frame, there are indentations for the insertion of protrusions from the adjacent foldable walls for the correct interconnection and holding of said adjacent foldable walls.

### Manufacturing an Hybrid Panel

In some embodiments, the next step is to connect a panel with a frame by one or more of the following processes: overmoulding process, gluing processes, welding processes, snapping processes, riveting processes and screwing processes, optionally the frame comprising all functional elements, thereby manufacturing a hybrid panel 506.

### Assembling the Final Product

In some embodiments, once all the parts are manufactured, they just need to be assembled together to provide the final product 508.

### Exemplary Short Process of Manufacture of a Hybrid Panel

In some embodiments, the short process comprises procuring a panel and adding a frame on at least parts of the panels. In some embodiments, the adding a frame provides functional structures to the panel. For example, strengthening frames, interconnection means (like hinges or protrusions or indentations), legs, walls, etc.

### Exemplary Products Comprising Hybrid Panels

### Exemplary Pallet

Referring now to FIGS. 6a-6c, showing schematic representations of an exemplary pallet 600 made from a hybrid panel, according to some embodiments of the invention. In some embodiments, the pallet comprises only a hybrid panel. In some embodiments, the pallet comprises a panel 602 (shown in FIGS. 6a-6c), comprising an alveolar core 604 and two protective layers 606 (shown in FIG. 6c). In some embodiments, the pallet comprises a frame 608 (shown in FIGS. 6a-6c), which comprises functional elements, for example, the legs of the pallet 610 (shown in FIGS. 6a-6c). In some embodiments, parts of the frame 608 are located inside the area of the panel 602, as shown by the leg 612 in FIGS. 6a-c.

### Exemplary Method of Manufacturing a Pallet

Referring now to FIG. 6d, showing a flowchart of an exemplary method of manufacturing a pallet made of a hybrid panel, according to some embodiments of the invention. In some embodiments, a pallet made of a hybrid panel is designed 614, comprising an assessment of the required functional elements required on the frame 616, for example, setting the locations of the legs, choosing the height of the legs, choosing the thickness of the frame, adding special elements to the legs, for example, making them complementary to each other to allow for stock piling of multiple pallets. In some embodiments, functional elements of the pallet are the legs, the number of legs, the geometry of the legs, the geometry of the legs that allows the pallets to be stacked on one another, etc. In some embodiments, a panel is cut according to the design of the pallet 618. In some embodiments, the cutting is performed on the areas where the frame will connect to the panel. In some embodiments, a frame and other parts are added to the cut panel 622.

Exemplary Pallet with Foldable Walls (Box)

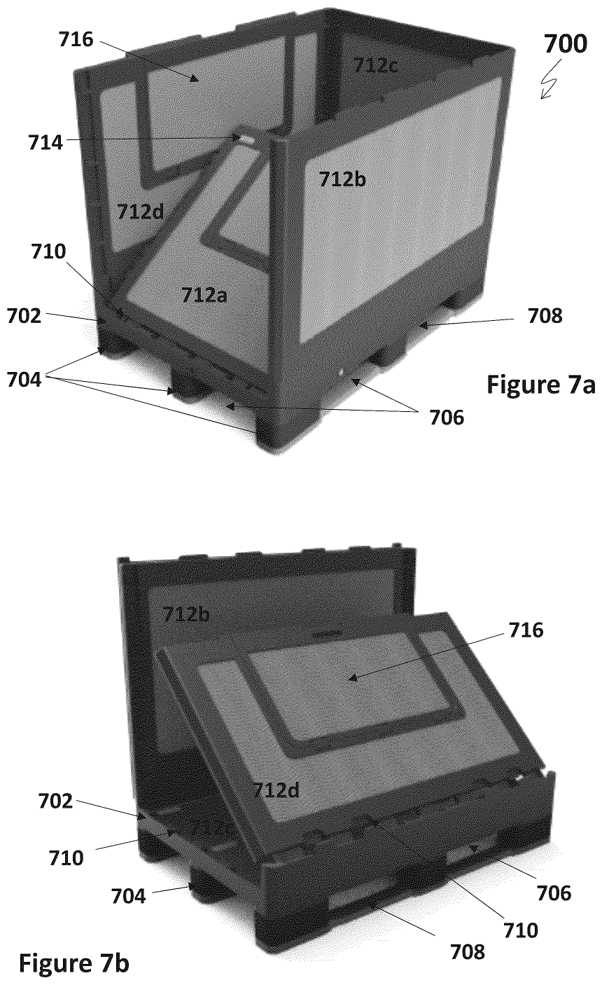

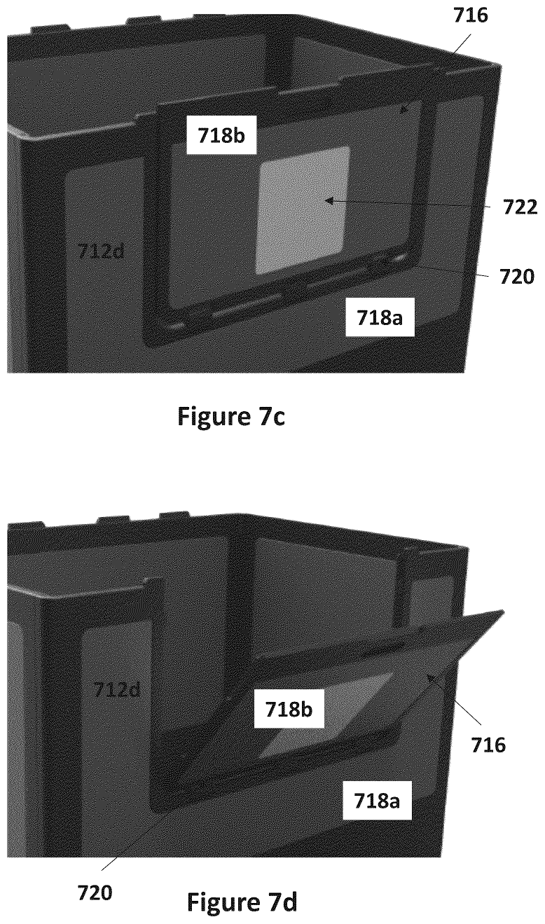

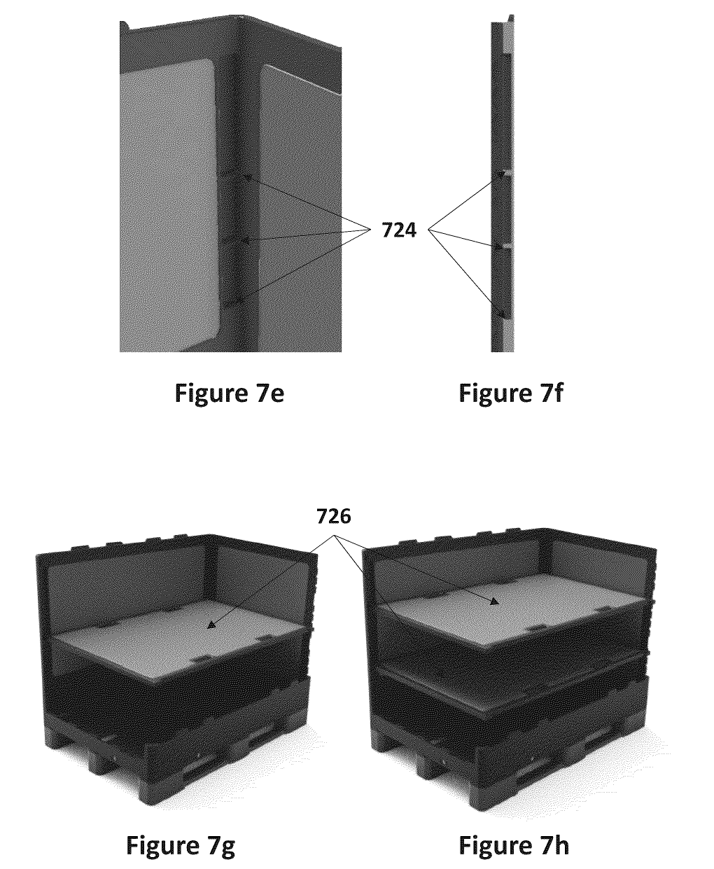

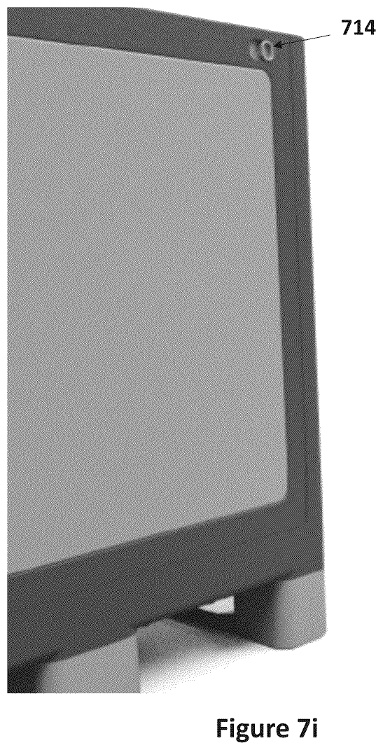

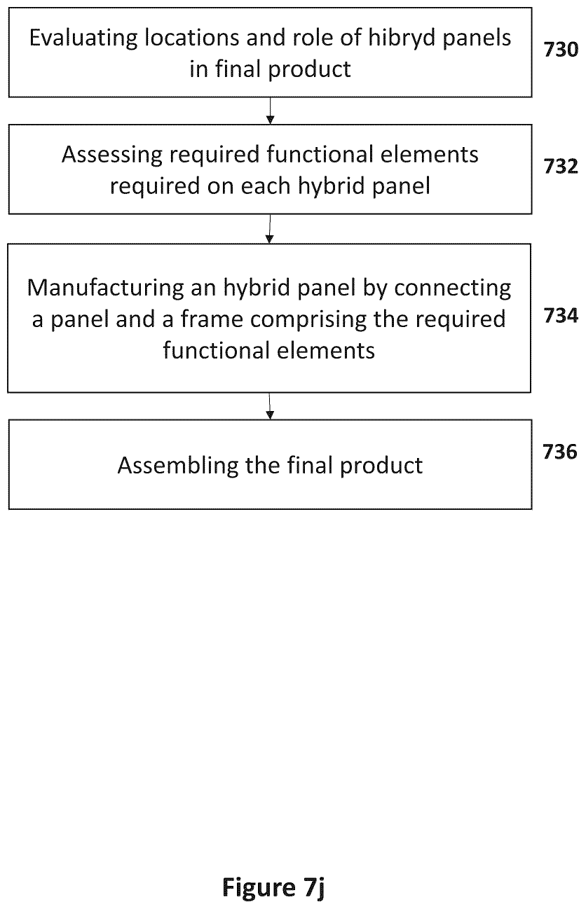

Referring now to FIGS. 7a-7i, showing schematic representations of an exemplary pallet with foldable walls 700 (referred hereinafter as box) made from a plurality of hybrid panels, according to some embodiments of the invention.

In some embodiments, the box comprises a base 702 comprising technical features of a pallet, for example, legs 704 and openings 706 for allowing a forklift to lift the box. In some embodiments, one or more legs are optionally interconnected 708 to each other for stability. In some embodiments, the base 702 is fully made of plastic. In some embodiments, the base 702 is made like pallet 600, made of a hybrid panel. In some embodiments, the base comprises built-in hinges 710 for the connection of the foldable walls 712a-d. In some embodiments, the box 700 comprises one or more hybrid panels used as the foldable walls 712a-d of the box 700. In some embodiments, the hybrid panels are manufactured as disclosed above. In some embodiments, functional features are added to the hybrid panels to function as foldable walls, for example, at the bottom of the hybrid panel built in hinges to match the built-in hinges 710 of the base. In some embodiments, optional features are added to the hybrid panels that function as foldable walls, for example, a locking mechanism between foldable walls 714, as shown in FIGS. 7a and 7i. In some embodiments, another optional feature is an opening window 716 on one or more of the foldable walls, to potentially help loading/unloading the box when all the walls are up, as shown for example in FIGS. 7a, 7b, 7c and 7d. In some embodiments, the foldable wall comprising an opening window is made of two distinct hybrid panels. Referring to FIGS. 7c and 7d, exemplary foldable wall 712d is made of two hybrid panels 718a and 718b. In some embodiments, each of them comprise a panel with a frame, where the frame comprises technical features (for example: hinges 720) for the attachment of the two hybrid panels to each other. In some embodiments, optionally, a plaque 722 is added to the foldable wall for writing the contents of the box or attaching bill of shipping and more. In some embodiments, the box 700 is configured to allow the addition of internal dividers, as shown for example in FIGS. 7e-7h. In some embodiments, on the internal side of two or more foldable walls, generated by the addition of functional features on the frame of those hybrid panels, there are indentations that generate one or more protrusions 724 on the foldable wall (on the frame of the hybrid panel). In some embodiments, one or more dividers 726 can be used in a single box 700. In some embodiments, the dividers themselves are also hybrid panels manufactured with functional features to perform as a divider and be held by the protrusions 724.

In some embodiments, the box comprises an optional cover (not shown), for covering the box 700, once it is loaded.

In some embodiments, when the foldable box 700 is fully folded, it can potentially become as thin as a regular pallet. In some embodiments, a potential advantage of this is that when needed to be returned, the boxes are folded and they take less space.

In some embodiments, the foldable container is characterized by a mechanical strength of from about 40% to about 50% higher than similar regular containers. In some embodiments, the mechanical strength is increased by the hybrid panels used in the foldable container.

In some embodiments, the foldable container is characterized by walls having a thickness from about 5% to about 20% thinner than similar regular containers. In some embodiments, the hybrid panels used for the foldable container allow the use of thinner walls without compromising the overall strength of the foldable container.

In some embodiments, the foldable container is characterized by having an internal storage space of from about 5% to about 10% higher than similar regular containers. In some embodiments, the fact that the hybrid panels are thinner than regular panels used for similar products, it allows to increase the internal storage space without increasing the overall dimensions of the foldable container. In some embodiments, the internal space storage comprises a base of from about 700×1000 mm to about 800×1300 mm, for example 770×1170 mm.

In some embodiments, the ratio between the height of a folded foldable container and the height of an unfolded foldable container is from about 1:3 to about 1:4.

Exemplary Method of Manufacturing a Pallet with Foldable Walls (Box)

Referring now to FIG. 7j, showing a flowchart of an exemplary method of manufacturing a pallet with foldable walls made of a plurality of hybrid panels, according to some embodiments of the invention.

In some embodiments, the planning process commences by evaluating the locations and roles of the plurality of hybrid panels in the box 730. For example, for the exemplary box 700 there are needed ten different hybrid panels: two full foldable walls, two foldable walls with windows, two windows, a cover (not shown) and three dividers (2+2+2+1+3=10). In this example, the base is made of a one piece of molded plastic.

In some embodiments, each hybrid panel is assessed for the required functional elements 732. For example, the foldable walls are interconnected to the base, for example, by built-in hinges located half on the frame and half on the base (they interconnect by clicking them together). Another example, on the internal side of the side of the frame, there are indentations for the insertion of protrusions from the adjacent foldable walls for the correct interconnection and holding of said adjacent foldable walls. Another examples, as disclosed above, the locking mechanisms, the dividers, etc.

In some embodiments, the next step is to connect a panel, comprising the necessary size, with a frame, the frame optionally comprises all functional elements, thereby manufacturing a hybrid panel 734.

In some embodiments, once all the parts are manufactured, they just need to be assembled together to provide the final product 736.

### Exemplary Rigid Container

Referring now to FIGS. 8a and 8b, showing a schematic representations of an exemplary rigid container 800, according to some embodiments of the invention. In some embodiments, an exemplary rigid container 800 comprises a panel 802, same as disclosed before, having a alveolar core 804 covered by two protective layers 806 (only the upper one is shown), and a frame, where the functional elements of the frame are the walls 808 of the rigid container.

### Exemplary Method of Manufacturing an Exemplary Rigid Container

Referring now to FIG. 8c, showing a flowchart of an exemplary method of manufacturing an exemplary rigid container made of a hybrid panel, according to some embodiments of the invention. In some embodiments, a rigid container made of a hybrid panel is designed 810, comprising an assessment of the required functional elements required on the frame 812, for example, the thickness of the walls, the locations of the reinforcements if required, etc. In some embodiments, the next step is to connect a panel with a frame by one or more of the abovementioned processes 814.

As used herein with reference to quantity or value, the term “about” means “within ±20% of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An hybrid panel, comprising
a. a panel comprising: a core, a first protecting layer on a first side of said core and a second protecting layer on a second side of said core; said panel defining an outside geometry thereof;
b. a frame portion which overlays at least a part of said panel, thereby changing said geometry of said panel at said part of said panel.

2. The hybrid panel according to claim 1, wherein said frame portion provides a structural function.

3. The hybrid panel according to claim 1, wherein said core is thinner at a location of connection between said frame portion and said panel in relation of the rest of said core where there is no connection with said frame portion.

4. The hybrid panel according to claim 1, wherein said core is made of one or more of thermoplastic material, resin, reinforced resin, wood and concrete.

5. The hybrid panel according to claim 1, wherein said first and said second protecting layers are made of one or more of thermoplastic material, resin, reinforced resin, wood and concrete.

6. The hybrid panel according to claim 1, wherein said frame portion is made of one or more of thermoplastic material, resin and reinforced resin.

7. The hybrid panel according to claim 1, wherein said panel is a sandwich panel.

8. The hybrid panel according to claim 1, wherein said core is a honeycomb core.

9. The hybrid panel according to claim 1, wherein at least one of the following is true:
a. said hybrid panel is lighter from about 5% to about 10% than a non-hybrid panel;
b. said hybrid panel is stronger from about 30% to about 60% than a non-hybrid panel
c. said hybrid panel is configured to carry from about 5% to about 10% more load than a non-hybrid panel.

10-11. (canceled)

12. The hybrid panel according to claim 1, wherein a surface of said hybrid panel is one or more of flat and without indentations or protrusions.

13. (canceled)

14. The hybrid panel according to claim 1, wherein said frame portion is attached to said panel by one or more of overmoulding process, gluing processes, welding processes, snapping processes, riveting processes and screwing processes.

15. A method of manufacturing a hybrid panel, comprising:
a. providing a panel;
b. framing said panel with enough material to change a geometry on at least a part of said panel.

16. The method according to claim 15, wherein said change a geometry comprises providing a structural function with said change.

17. The method according to claim 15, wherein said enough material comprises providing a framing portion of at least 2 mm thickness.

18. The method according to claim 15, wherein said framing said panel further comprises providing a frame comprising functional elements to be added to said panel.

19. The method according to claim 15, wherein said providing a panel comprises one or more of:
a. providing a panel comprising a honeycomb core, a first protecting layer on a first side of said honeycomb core and a second protecting layer on a second side of said honeycomb core;
b. providing a panel comprising a wooden core, a first protecting layer on a first side of said wooden core and a second protecting layer on a second side of said wooden core;
c. providing a panel comprising a thermoplastic core, a first protecting layer on a first side of said thermoplastic core and a second protecting layer on a second side of said thermoplastic core;
d. providing a panel comprising a resin core, a first protecting layer on a first side of said resin core and a second protecting layer on a second side of said resin core;
e. providing a panel comprising a reinforced resin core, a first protecting layer on a first side of said reinforced resin core and a second protecting layer on a second side of said reinforced resin core;
f. providing a panel comprising a concrete core, a first protecting layer on a first side of said concrete core and a second protecting layer on a second side of said concrete core.

20-24. (canceled)

25. The method according to claim 15, wherein said material is one or more of thermoplastic material and recycled thermoplastic material.

26. (canceled)

27. The method according to claim 15, wherein said framing said panel comprises attaching said frame to said panel by one or more of overmoulding process, gluing processes, welding processes, snapping processes, riveting processes and screwing processes.

28. The method according to claim 15, wherein said hybrid panel is characterized by one or more of the following:
a. lighter from about 5% to about 10% than a non-hybrid panel;
b. stronger from about 30% to about 60% than a non-hybrid panel;
c. configured to carry from about 5% to about 10% more load than a non-hybrid panel.

29-30. (canceled)

31. The method according to claim 15, wherein a surface of said hybrid panel is one or more of flat and without indentations or protrusions.

32-57. (canceled)
